(19) United States
(12) Patent Application Publication
(10) Pub. No.: US 2014/0058672 A1
(43) Pub. Date: Feb. 27, 2014

(54) CALCULATING A TRAVEL ROUTE BASED ON A USER'S NAVIGATIONAL PREFERENCES AND TRAVEL HISTORY

(71) Applicant: Google Inc., Mountain View, CA (US)

(72) Inventors: Andrew Theodore WANSLEY, San Francisco, CA (US); Rita Chen, Sunnyvale, CA (US); Sean Yaoxing Liu, Sunnyvale, CA (US)

(73) Assignee: Google Inc., Mountain View, CA (US)

(21) Appl. No.: 13/956,182

(22) Filed: Jul. 31, 2013

Related U.S. Application Data
(60) Provisional application No. 61/691,750, filed on Aug. 21, 2012.

(51) Int. Cl. G01C 21/34

(52) U.S. Cl. CPC G01C 21/3484
USPC 701/533; 701/540

(57) ABSTRACT

The disclosed subject matter relates to computer-implemented methods for calculating a travel route based on navigational preferences and travel history of a user. In one aspect, a method includes storing the navigational preferences and travel history of the user. The stored navigational preferences include routing preferences and points of interest of the user. The travel history of the user includes location data from a respective date and time received from a location-aware device associated with the user. The method further includes receiving request for a travel route from an origin location to a destination location. The method further includes calculating, in response to the received request, the travel route from the origin location to the destination location, based on the stored navigational preferences and the stored travel history of the user.

### CROSS-REFERENCES TO RELATED APPLICATIONS

The present application claims the benefit of U.S. Provisional Patent Application Ser. No. 61/691,750, titled “Calculating a Travel Route Based on a User's Navigational Preferences and Travel History,” filed on Aug. 21, 2012, which is hereby incorporated by reference in its entirety for all purposes.

### BACKGROUND

The present disclosure generally relates to calculating a travel route, and more particularly to calculating a travel route based on a user's navigational preferences and travel history.

### SUMMARY

The disclosed subject matter relates to a computer-implemented method for calculating a travel route based on navigational preferences and travel history of a user. The method includes storing the navigational preferences and travel history of the user. The stored navigational preferences include routing preferences and points of interest of the user. The travel history of the user includes location data from a respective date and time received from a location-aware device associated with the user. The method further includes receiving request for a travel route from an origin location to a destination location. The method further includes calculating, in response to the received request, the travel route from the origin location to the destination location, based on the stored navigational preferences and the stored travel history of the user.

The disclosed subject matter further relates to a system for a travel route based on navigational preferences and travel history of a user. The system includes a memory which includes instructions for calculating a travel route based on navigational preferences and travel history of a user. The processor is configured to execute the instructions to store the navigational preferences and travel history of the user. The stored navigational preferences include routing preferences and points of interest of the user. The travel history of the user includes location data from a respective date and time received from a location-aware device associated with the user. The processor is further configured to receive a request for a travel route from an origin location to a destination location. The processor is further configured to calculate, in response to the received request, the travel route from the origin location to the destination location, based on the stored navigational preferences and the stored travel history of the user. The processor is further configured to provide, for display, the travel route

The disclosed subject matter further relates to a machine-readable medium including machine-readable instructions for causing a processor to execute a method for calculating a travel route based on navigational preferences and travel history of a user. The method includes storing the navigational preferences and travel history of the user. The stored navigational preferences include routing preferences and points of interest of the user. The travel history of the user includes location data from a respective date and time received from a location-aware device associated with the user. The method further includes receiving request for a travel route from an origin location to a destination location. The method further includes calculating, in response to the received request, the travel route from the origin location to the destination location, based on the stored navigational preferences and the stored travel history of the user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### DESCRIPTION OF DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates an example of an architecture for calculating a travel route based on navigational preferences and travel history of a user.

FIG. 2 is a block diagram illustrating an example of a client device and an example of a server from the architecture of FIG. 1 according to certain aspects of the disclosure.

FIG. 3 illustrates an example of a process for calculating a travel route based on navigational preferences and travel history of a user.

FIGS. 4A-4P are associated with the example of the process of FIG. 3.

FIG. 5 conceptually illustrates an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Users often wish to obtain directions between two locations. To that end, users typically enter their origin and destination addresses into a map location. Several GPS navigation devices offer information about “points of interest” such as gas stations, restaurants, and hotels. Users can select a particular point of interest and receive navigational instructions to the selected location. Currently, map applications and GPS navigation devices offer limited options related to selecting a route between an origin location and a destination location. Such options include a shortest route, a fastest route, and avoiding toll roads. However, these options do not take into consideration a particular user's navigational preferences and travel history.

The subject technology relates to calculating a travel route based on navigational preferences and travel history of a user. The subject technology involves storing the navigational preferences and the travel preferences of the user. The stored navigational preferences include routing preferences and points of interest of the user. Routing preferences can include a preference for a shortest path, a fastest path, a particular location, and/or a particular path. Routing preferences can also include a preference for avoiding routes and/or locations.

The points of interest of the user can be included in the stored navigational preferences based on, for example, a check-in, or an Internet search performed by the user. The travel history of the user includes location data from a respective date and time received from a location-aware device associated with the user.

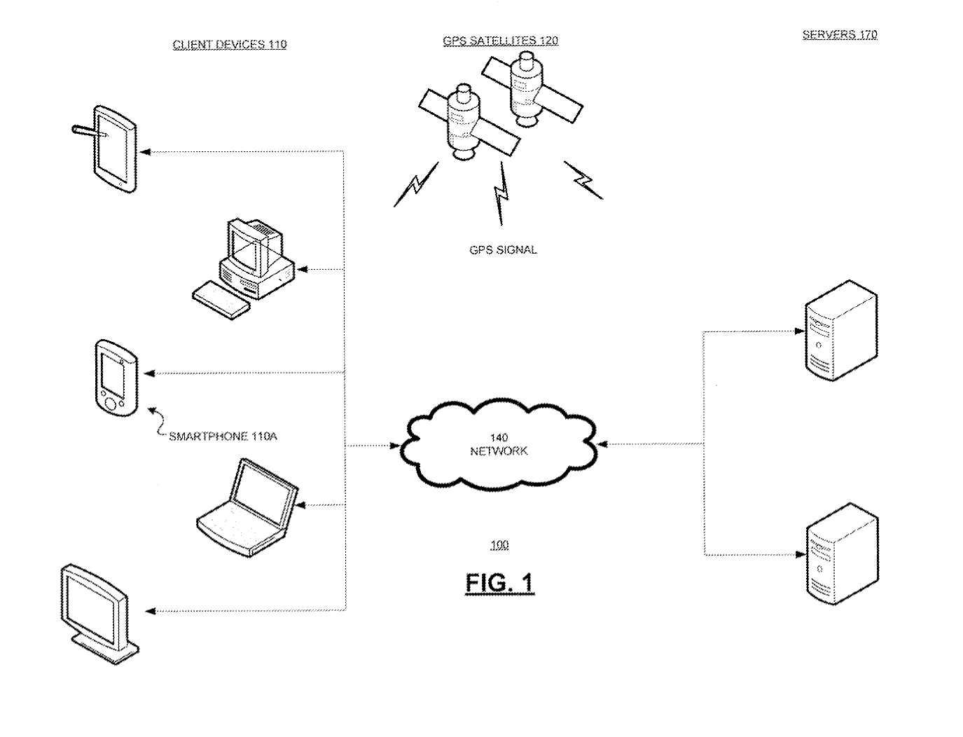

FIG. 1 illustrates an example of an architecture 100 for calculating a travel route based on navigational preferences and travel history of the user. The architecture 100 includes client devices 110 and servers 170 connected over a network 140.

The client devices 110 can be, for example, mobile computers, tablet computers, mobile devices (e.g., a smartphone or PDA), desktop computers, set top boxes (e.g., for a television), video game consoles, or any other devices having appropriate processing capabilities, communications capabilities, and memory. Each client device 110 is configured to include an input device for accepting user input, and an output device to display information to the user.

The clients 110 can be connected to the network 140. The network 140 can include any one or more of a personal area network (PAN), a local area network (LAN), a campus area network (CAN), a metropolitan area network (MAN), a wide area network (WAN), a broadband network (BBN), the Internet, and the like. Further, the network 140 can include, but is not limited to, any one or more of the following network topologies, including a bus network, a star network, a ring network, a mesh network, a star-bus network, tree or hierarchical network, and the like.

The client devices 110 are location-aware devices. The term ‘location-aware device’ as used herein encompasses its plain and ordinary meaning, including, but not limited to any device which is capable of determining its location. For example, a smartphone 110A capable of determining its location based on a GPS signal received from GPS satellites 120 may be considered a location-aware device. As another example, a client device 110 capable of determining its location based on IP geolocation techniques and/or wireless triangulation techniques may be considered a location-aware device.

Each location-aware client device 110 is configured to include a location-aware module which performs the function of determining the location of the client device 110. The location-aware module provides location data to the server(s) 170. Based on the location data, the server(s) 170 can store the user's travel history.

The servers 170 can be for example, stand-alone servers, shared servers, dedicated servers, cluster/grid servers (e.g., a server farm), or cloud servers. Each of the servers 170 may include one or more processors, communications modules, and memory. The servers 170 may be configured to distribute workload (e.g., for loadbalancing) across multiple servers. The server(s) 170 receive location data from the client device 110. The server(s) 170 store the received location data for further processing.

It should be noted that regardless of how any information is obtained by the server 170, appropriate efforts may be made to protect the user's privacy rights. For example, collection and/or storage of location data may be on an opt-in basis so that data is not collected unless the user grants permission to do so. Additionally, steps may be taken to anonymize information to protect the user's privacy rights.

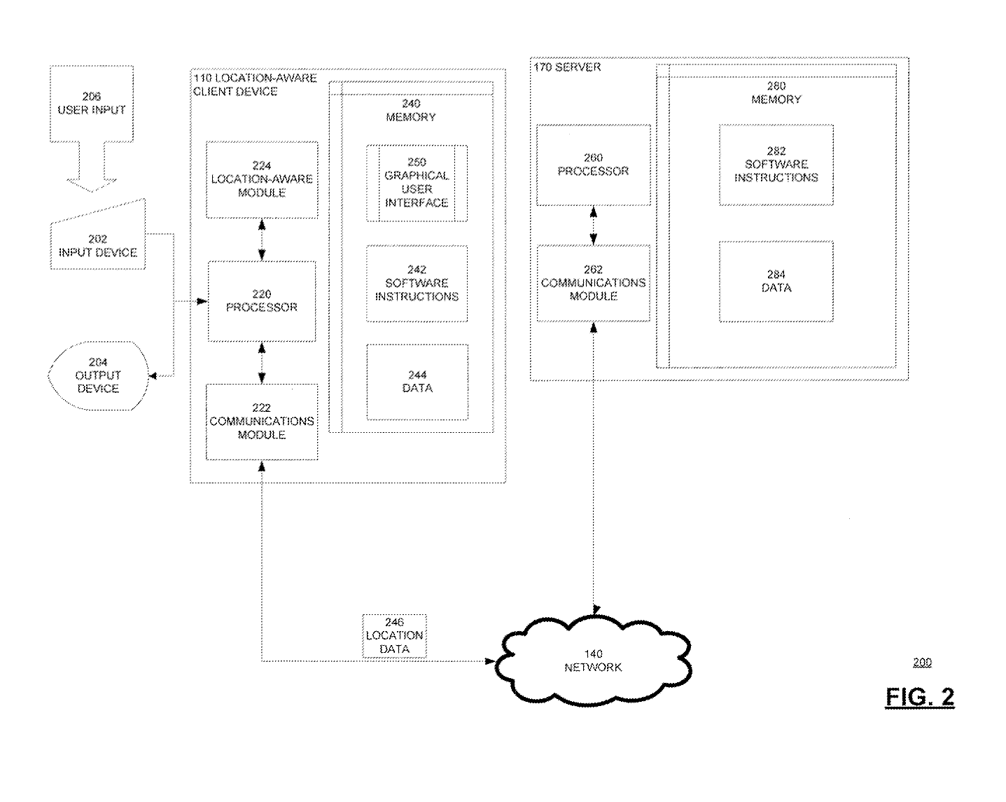

FIG. 2 is a block diagram 200 illustrating an example of a location-aware client device 110 and an example of a server 170 in the architecture 100 of FIG. 1 according to certain aspects of the disclosure.

The location-aware client device 110 includes an input device 202, an output device 204, a processor 220, a communications module 222, a location-aware module 224, and memory 240. The input device 202 can be a touchscreen, a mouse, a keyboard, or any other device to enable a user to supply input 206 to the client device 110. The output device 204 can be a display screen.

The location-aware client device 110 is connected to the network 140 via a communications module 222. The communications module 222 is configured to interface with the network 140 to send and receive information, such as data (e.g., location data 246), requests, responses, and commands to other devices on the network 140. The communications module 222 can be, for example, a modem or Ethernet card.

The memory 240 includes software instructions 242 and data 244 to enable interaction with the server 170. The memory includes a graphical user interface 250 which allows a user to interact with the location-aware client device 110, and can be used to display information to the user. The graphical user interface 250 may installed locally at the client device 110 and/or downloaded from the server 170.

The location-aware client device 110 includes a location-aware module 224. The location-aware module 224 is capable of determining its geographic location. For example, the location aware module 224 may determine its location based on a GPS signal received from GPS satellites 120. The location aware module may rely on wireless triangulation techniques and/or IP geolocation techniques to estimate, determine, and/or further refine its location.

The geographic location determined by the location-aware module 224 can be included in the location data 246 provided to the server 170. This location data 246 can be used to determine the user's travel history.

The server 170 includes a memory 280, a processor 260, and a communications module 262. The memory 280 includes software instructions 282 for storing and/or processing the data 284 for calculating a travel route based on the navigational preferences and travel history of the user. The server 170 is connected to the network 140 via a communications module 262. The communications module 262 is configured to interface with the network 140 to send and receive information, such as data (e.g., location data 246), requests, responses, and commands to other devices on the network 140. The communications module 262 can be, for example, a modem or Ethernet card.

The processor 260 of the server 170 is configured to execute instructions, such as instructions physically coded into the processor 260, instructions read from the memory 280, or a combination of both. As an example, the processor 260 of the server 170 executes instructions for calculating a travel route based on the navigational preferences and the travel history of the user.

Once the instructions from the memory 280 are loaded, the processor 260 is configured to store the navigational preferences and the travel history of the user. The stored navigational preferences include routing preferences and points of interest of the user. The travel history of the user includes location data (e.g., 246) from a respective date and time received from a location-aware device (e.g., 110) associated with the user. The processor 260 is further configured to receive a request for a travel route from an origin location to a destination location. The processor 260 is further configured to calculate, in response to the received request, the travel route from the origin location to the destination location, based on the stored navigational preferences and the stored travel history of the user.

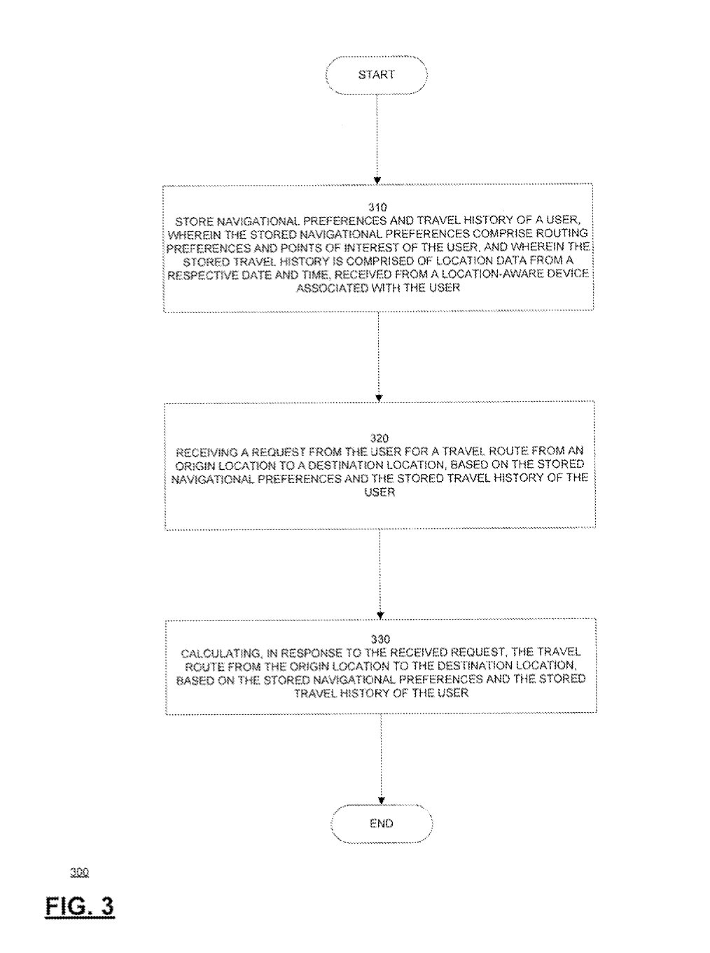

FIG. 3 illustrates an example of a process 300 for calculating a travel route based on navigational preferences and travel history of the user. In step 310, the navigational preferences and the travel history of the user are stored as data 284 in the memory 280 of the server 170. The navigational preferences of the user include routing preferences and points of interest of the user. The travel history includes location data 246 from a respective date and time received from the location-aware device 110 associated with the user.

The points of interest of the user can be included in the stored navigational preferences in a number of ways. For example, a point of interest can be included in the stored navigational preferences based on a check-in. A check-in is an indication of the user's presence at, or the user's interest in the location (“check-in location”) corresponding to the check-in.

A check-in may be performed on demand. For example, in response to an input (e.g., an input 206 received via the input device 202), location data 246 indicating the user's presence at the check-in location can be sent to the server 170. For example, a user present at a particular restaurant may indicate his presence by performing a check-in associated with that restaurant.

A check-in may be performed automatically. For example, a user may grant permission for location data 246 to automatically be provided to the server 170, at certain intervals or continuously. Thus, as the user travels with the location-aware client device 110, check-ins associated with the various locations visited by the user, may be performed automatically.

Points of interest can be added to the user's navigational preferences remotely. That is, a user may add a location as a point of interest without being present at that location to perform a check-in. For example, a user who enjoys dining at a particular restaurant may add that restaurant as a point of interest without being present at that restaurant. Adding a point of interest may thought of as performing a check-in remotely.

The travel history of a user includes location data 246 from respective dates and times. That is, the travel history of the user includes locations identified by the location data 246 received by the server 170.

A user can select whether or not certain locations are included in his travel history. For example, to include locations in travel history, the user may enable the location-aware module 224 to automatically provide location data 246 to the server 170 prior to visiting those locations. Similarly, to exclude locations from being included in the travel history, the user may disable the location-aware module 224 prior to visiting those locations.

The server 170 retrieves and analyzes various aspects of the locations in the user's travel history to prepare and/or further refine the user's navigational preferences. For example, the server 170 can, based on the user's travel history, determine travel routes preferred by the user.

The various aspects of a particular location may include one or more environmental factors. Environmental factors can include crime statistics, street conditions, demographic information, and/or weather conditions associated with a particular location. Street conditions can include length (i.e., distance), complexity (e.g., number of turns), grade (e.g., incline), elevation, width, number of lanes, number of traffic lights and/or stop signs, railroad crossings, school zones, traffic speed, street closures, detours (e.g., due to construction), potholes, street lighting, police presence, a police camera, or any other information that can be related to a street. Demographic information can be any statistical characteristics of the local population. For example, demographic information can include statistics related to the gender, race, age, disabilities, mobility, home ownership, employment status, and/or income levels of the residents of the local area.

Further information about the various aspects (e.g., environmental factors) may be retrieved by the server 170 based on information that is publicly available, explicitly received from the user, and/or implicitly received from the user. Publicly available information may be retrieved by accessing various public information databases and/or Internet searches. For example, crime statistics provided by the FBI and/or various police departments can be correlated to specific locations. News stories and/or social media can also be searched to obtain information associated with a particular location.

Information about a particular location may be explicitly received at the server 170 from the user. For example, a location may be explicitly designated by a user as his home, workplace, and so forth. As another example of explicitly received information, the user can provide a descriptor to provide additional context for a location.

Information about a particular location may be implicitly received from the user. For example, if the user grants access privileges to the server 170 for accessing a particular information repository, any information retrieved from that information repository may be considered to be implicitly received by the server 170. Examples of information repositories include a user's Internet browsing history, Internet search history, email accounts, social media accounts, and financial transactions.

The server 170 can analyze the information retrieved from public sources, explicitly received from the user, and/or implicitly received from the user. Based on the analysis, the server 170 can determine and/or further refine the user's navigational preferences. As an example, the server 170 may treat a search query for a particular coffee shop as an indication that the user may enjoy visiting that coffee shop. The server 170 may, based on the Internet search, add the coffee shop as a point of interest of the user. Thus, implicitly received information, such as an Internet search, is another way that a point of interest can be included in the stored navigational preferences of the user.

Based on an analysis of the received location data 246, and the various information related to the corresponding locations, the server 170 associates an affinity value with each location. The affinity value is a numerical measure of a user's preference for, or interest in a location. As an example, if the user frequently visits a particular location, the user's affinity value for that location will be higher than a location that the user visits less frequently.

The affinity value of a location can be affected by whether it is included in the user's points of interest, and/or information retrieved from the user's information repositories. For example, a location included in the user's points of interest would have a higher affinity value than a location that is not included in the user's points of interest. Similarly, a location included in the user's information repositories (e.g., email, Internet search history, Internet browsing history) would have a higher affinity value than a location that is not included in the user's information repositories.

Just as some types of information can have a positive influence on the affinity value of a particular location, other types of information can have a negative influence. As an example, if the user avoids traveling along a particular route, the affinity value for the locations corresponding to that travel route may be decreased.

A user's avoidance of a route (e.g., a particular street, a particular intersection) may be detected based on the user's travel history. For example, based on the user's travel history, the user's actual travel route may be compared to the route that was calculated for the user, a shortest travel route, or a fastest travel route from the origin location to the destination location. That is, an avoidance may be indicated when the user opts for a longer route, a more complicated route (e.g., with more turns), or a slower route than the route that is calculated for the user, the shortest possible route, the simplest possible route (e.g., with fewest turns), or the fastest possible route.

The server 170 infers a cause for the avoidance. To infer the cause of the avoidance, the server 170 compares one or more locations on the avoided route to one or more locations on the user's travel route. That is, the server 170 compares the avoided route to the actual travel route of the user.

In performing the comparison, the server 170 analyzes any available data related to the avoided route. The server 170 can retrieve traffic reports, crime statistics, news reports, construction information, street lighting conditions, power outages, and any other available data related to the locations on the avoided route. The server 170 then compares the retrieved data to similar data related to the location(s) on the user's actual travel path.

Based on the comparison, the server 170 infers one or more causes for the avoidance. The server 170 adds to the user's stored navigational preferences, the cause for the avoidance and/or the avoided route. Furthermore, based on the comparison, the server 170 may lower the affinity value of the avoided location on the avoided route. For example, the server 170 may associate a negative affinity value with the avoided location on the avoided route.

Just as avoided locations and/or routes are analyzed, locations that are most frequently checked-in from are also analyzed. For example, location data 246 may be received most frequently from a user's home and/or workplace. Based on the frequency of the user's visits, these locations may have high affinity values associated with them. However, the user may not wish to have his home and/or workplace included in routes to and from other locations. On the other hand, a user may wish to have other locations (e.g., a coffee shop that the user visits frequently) with high affinity values to be included in a routes to and from other locations.

In order to determine how to treat specific locations with high affinity values, the server 170 attempts determine the nature of those locations. To designate a particular location as the user's home and/or workplace, the server 170 correlates the user's travel history with factors such as day, date, time, public holidays, business hours associated with the location, and/or weather.

As an example of utilizing day and time, the server 170 treats the user's presence at or near a location for extended periods during business hours associated with that location, as an indication that the location is the user's workplace. Similarly, the user treats the user's presence at or near a location for extended periods of time during other hours (e.g., night hours) as an indication that the location is the user's residence.

To keep the user's navigational preferences current, the significance of any single location diminishes over time. This diminishing in importance may be referred to as a time decay aspect of a location. This time decay aspect prevents a particular location from permanently affecting the user's navigational preferences.

In step 320, an origin location and a destination location are received by the server 170 from the client device 110. The origin location may be a start location or a current location. A start location is one which is explicitly specified by the user. A current location is one which is discerned based on the user's detected current geographic location. The start location and the current location can be the same.

In step, 330, in response to the received request, the travel route from the origin location to the destination location is calculated based on the user's navigational preferences and stored travel history.

The travel route is calculated based on a heuristic search. The heuristic search algorithm explores a number of travel paths from the origin location to the destination location. Each travel path can include one or more route segments. A route segment is the shortest navigable route between two points. That is, a route segment is the path that can be traveled along a navigable route between two points.

The navigability of a travel path is defined in context of the type of transportation being used to navigate that potential travel path. This is because a travel path navigable using one form of transportation may not be feasibly navigable using another form of transportation. For example, a person walking from one point to another may take a shortcut by walking across a grass field. However, this travel path would not be feasibly navigable in a car. The type of transportation being used may be specified by a user. The type of transportation may be discerned based on the user's speed of travel and/or the routes taken.

Each route segment may include locations with affinity values associated with them. For example, a route segment frequently traveled by the user may have locations with higher affinity values than a route segment less frequently traveled by the user. As another example, a route segment avoided by the user may have a lower affinity value than a route traveled by the user. The affinity values of the various route segments of a travel path can be aggregated to determine the ranking of that travel path as a whole.

In addition to the affinity values, each route segment may be affected by environmental factors. For example, street conditions such as the length of a route segment, complexity (e.g., number of turns), and traffic speed may affect the desirability of the route segment, and consequently the travel path as a whole. Therefore, the travel paths may be altered to select the route segments with the most favorable environmental factors.

Based on the affinity values and the environmental factors, the travel routes are ordered from most desirable to least desirable. The travel routes may then be provided for display.

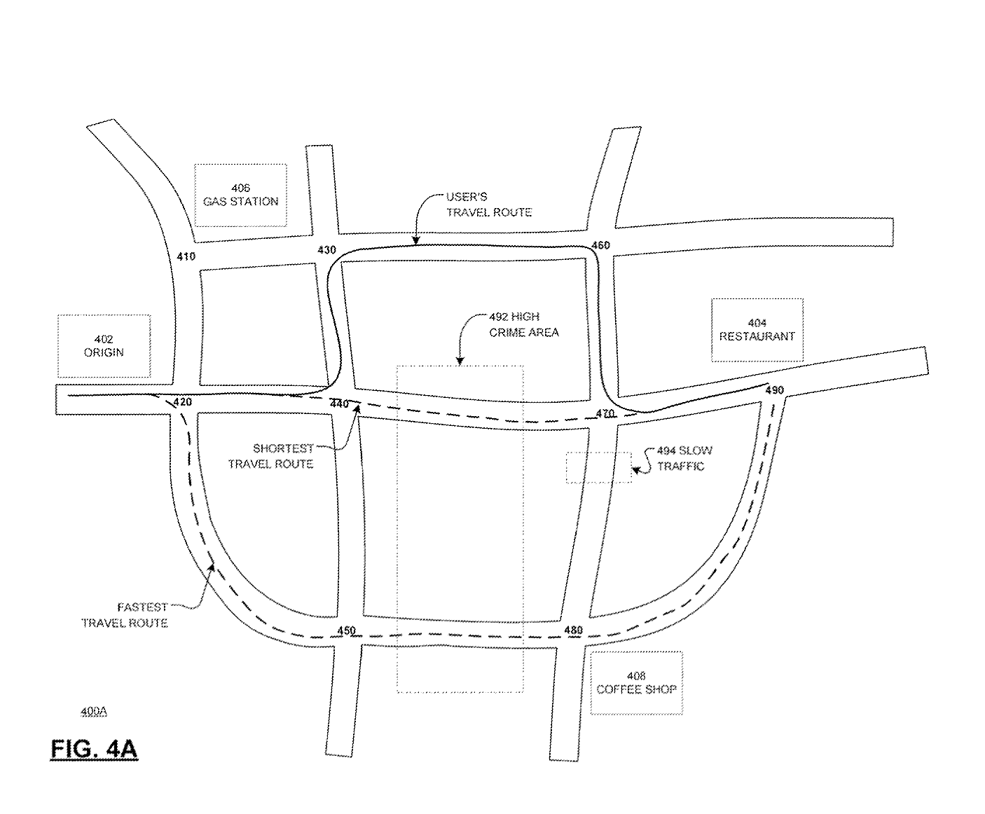

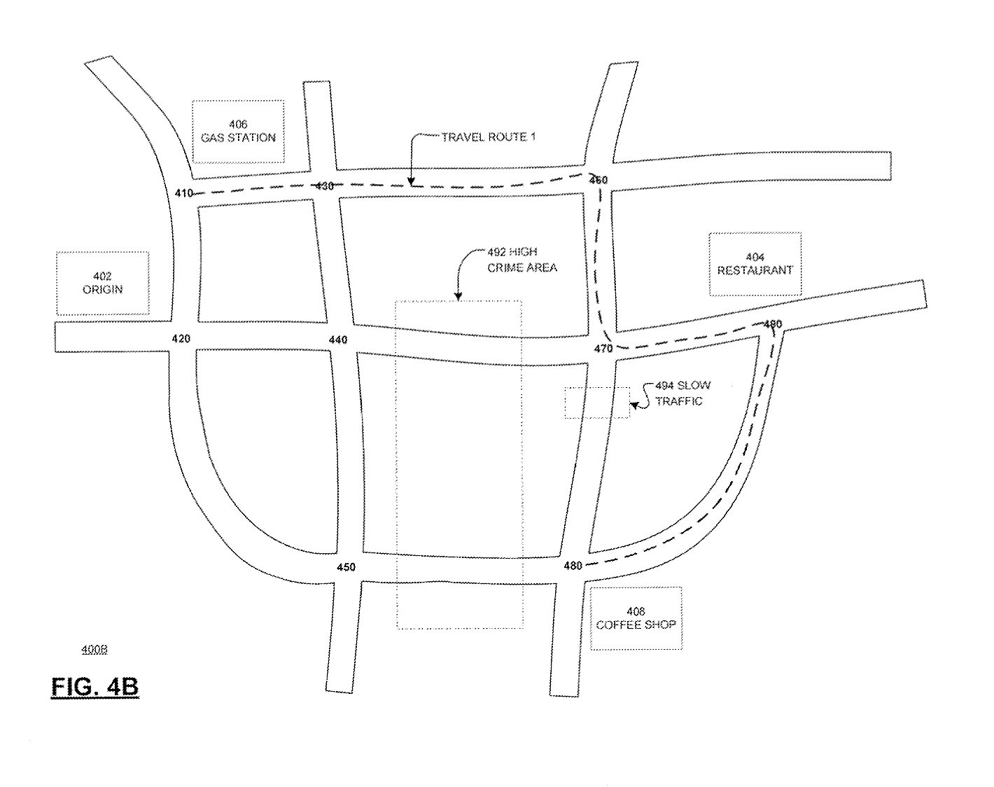

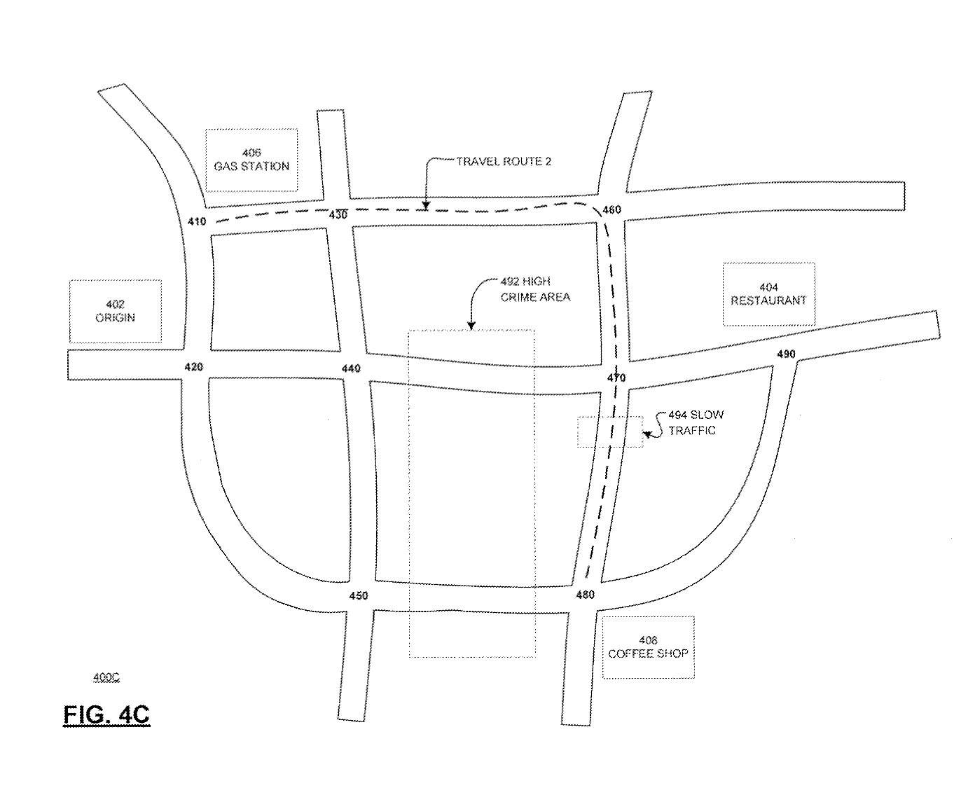

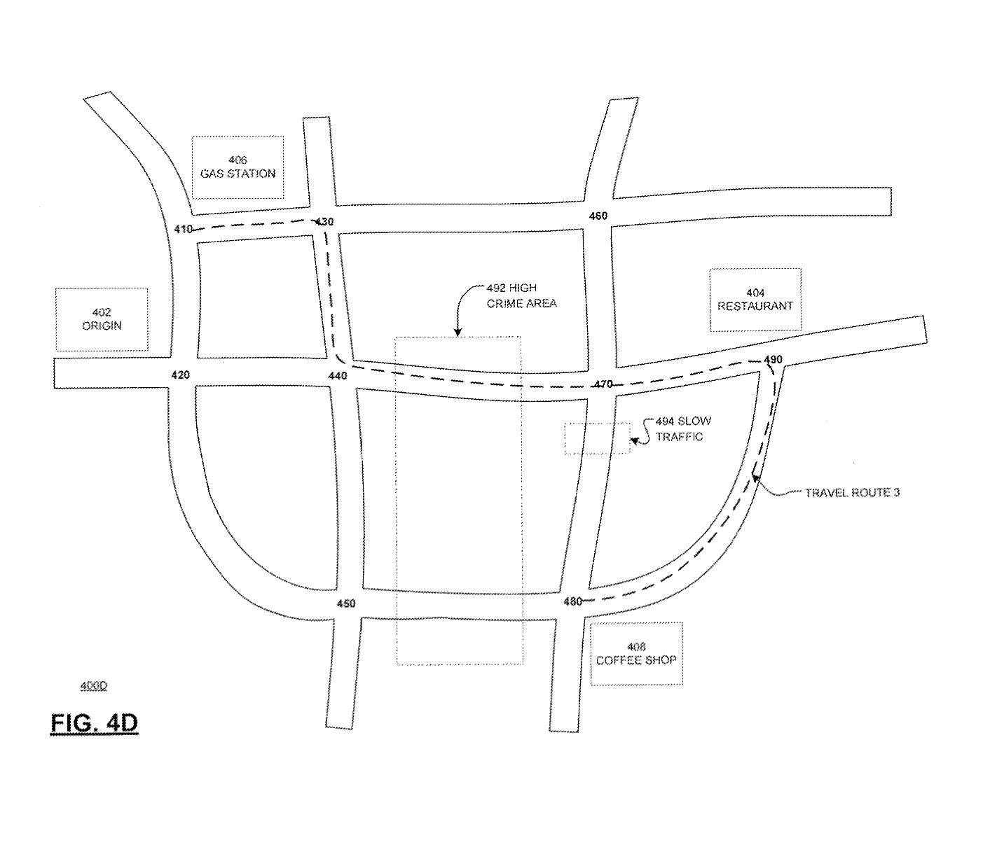

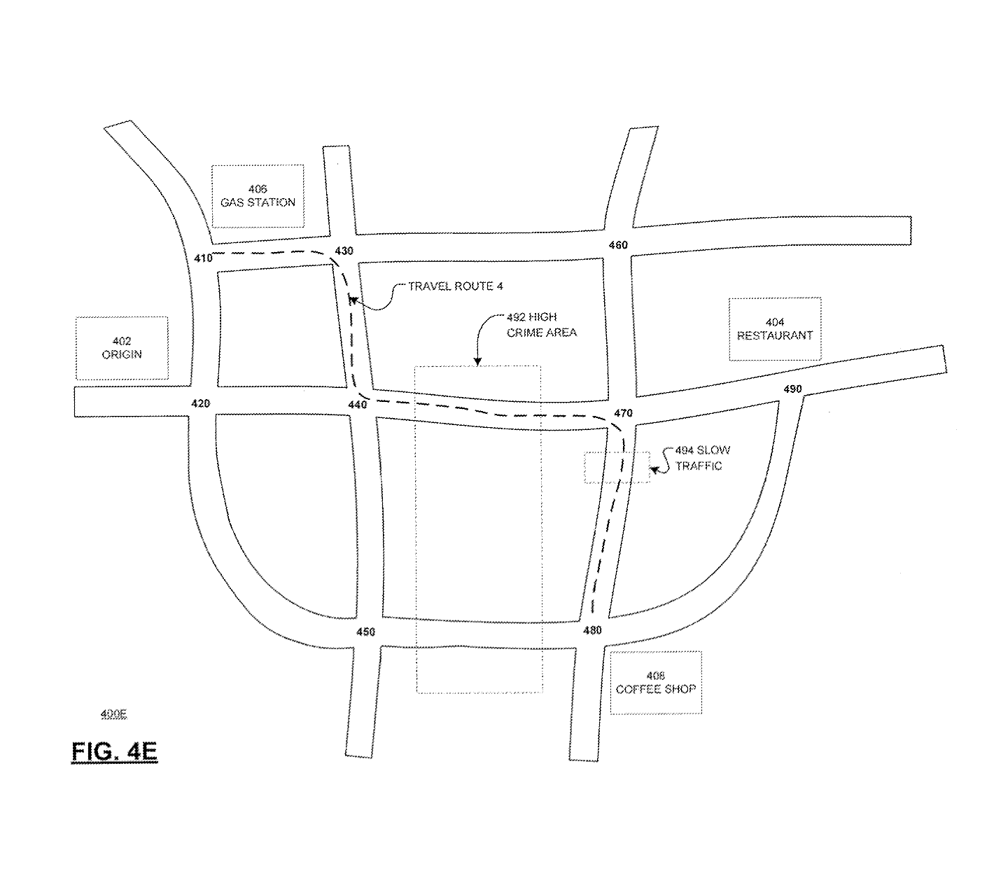

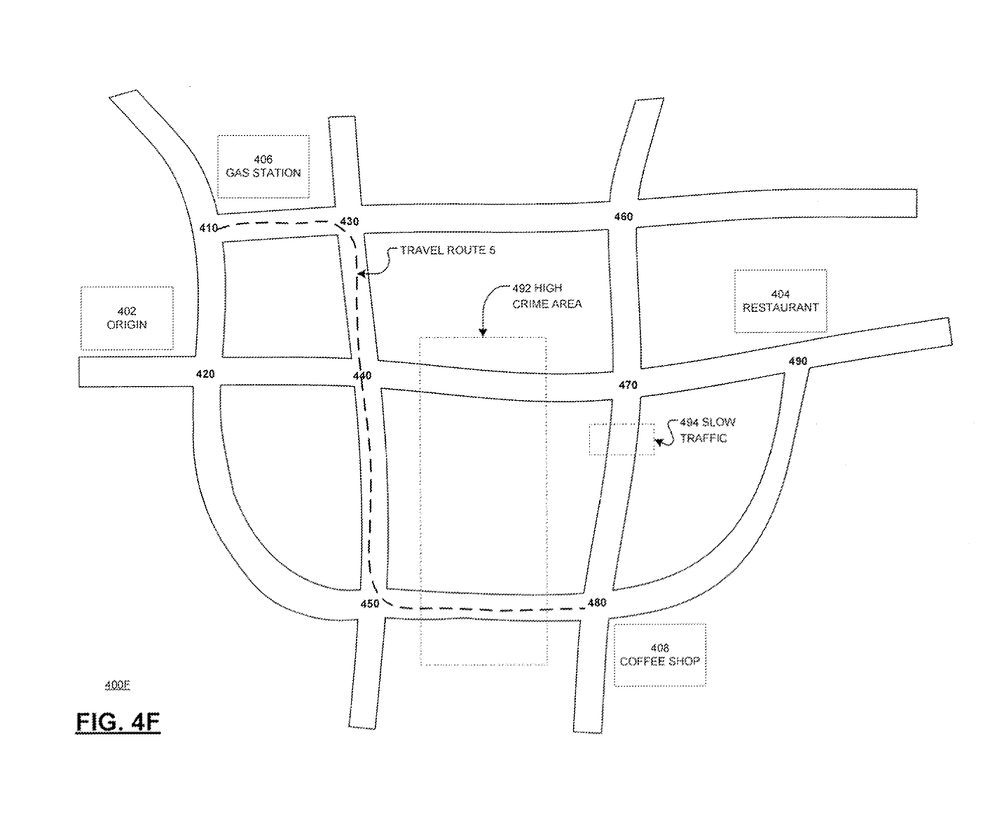

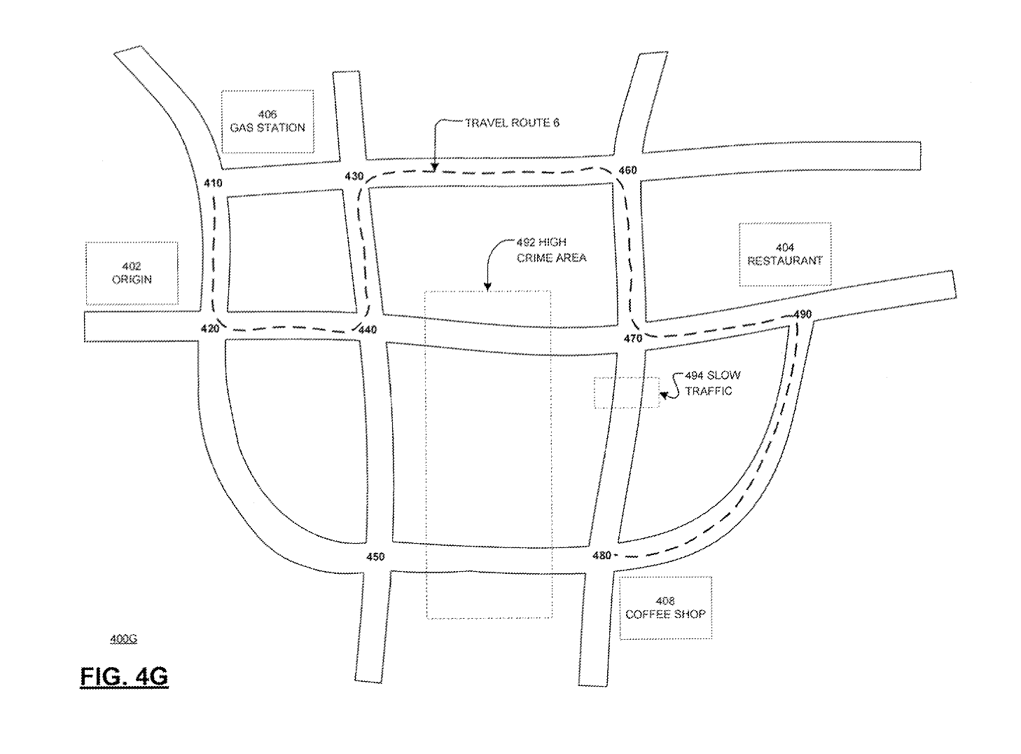

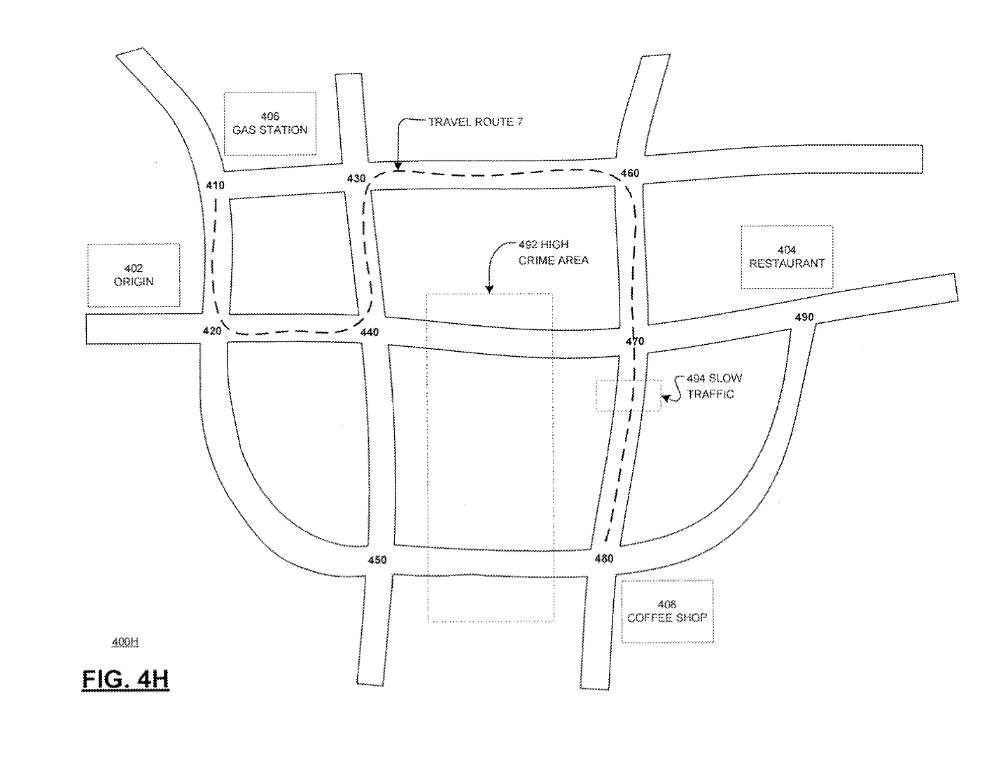

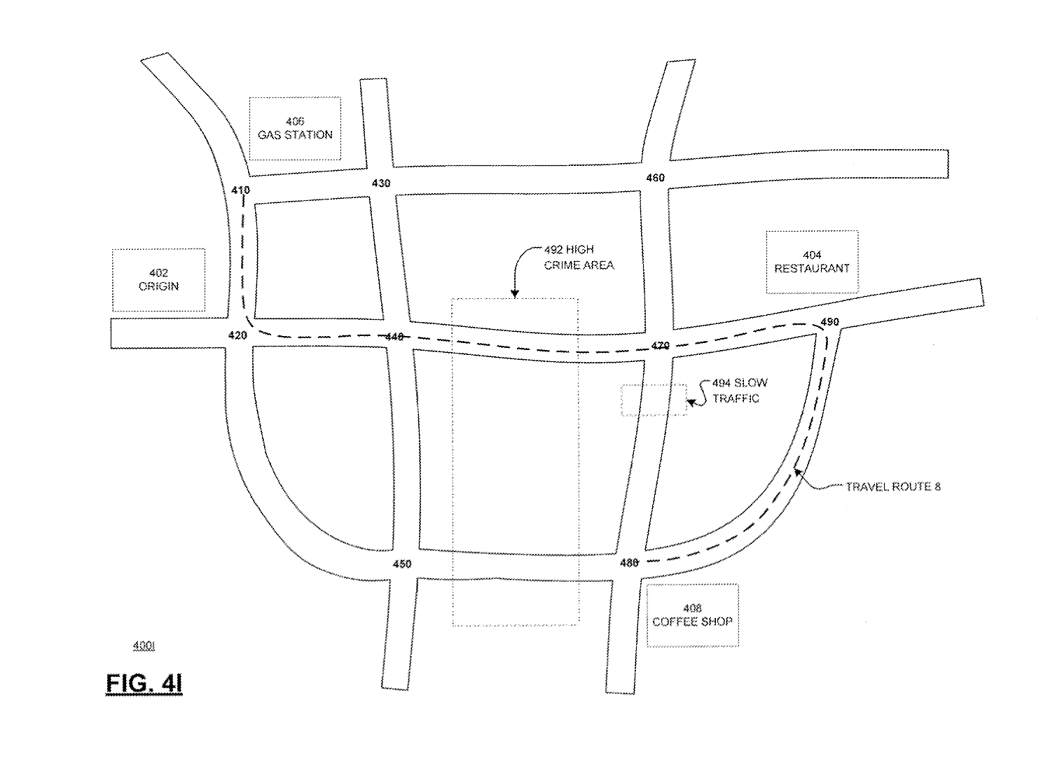

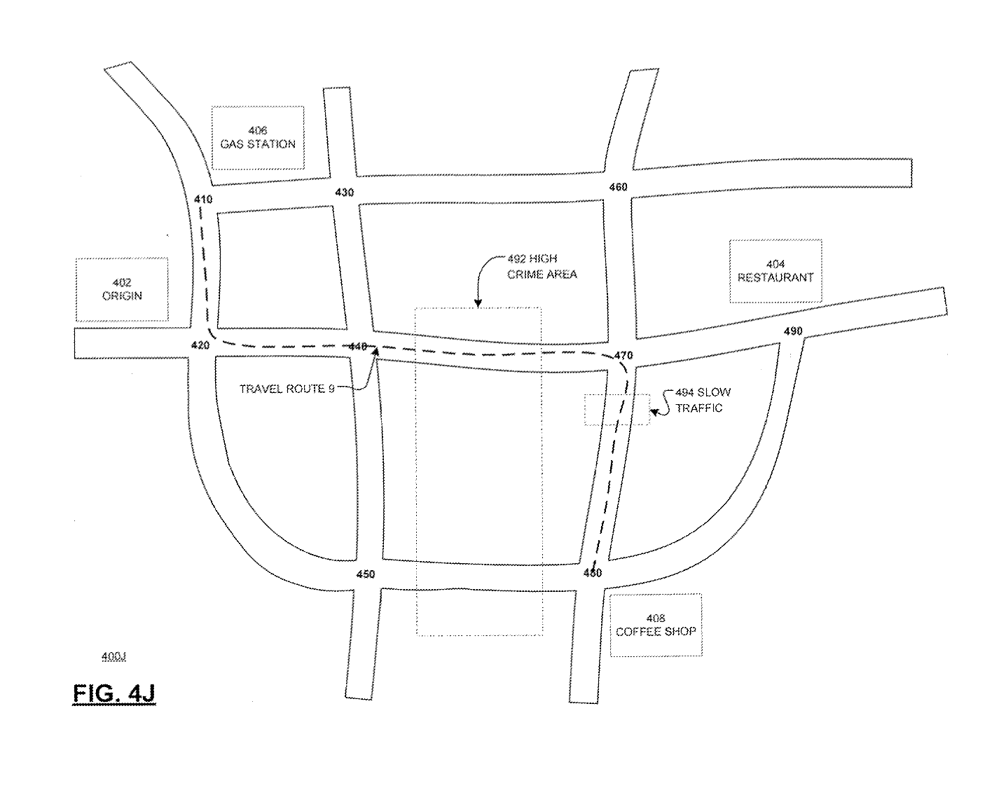

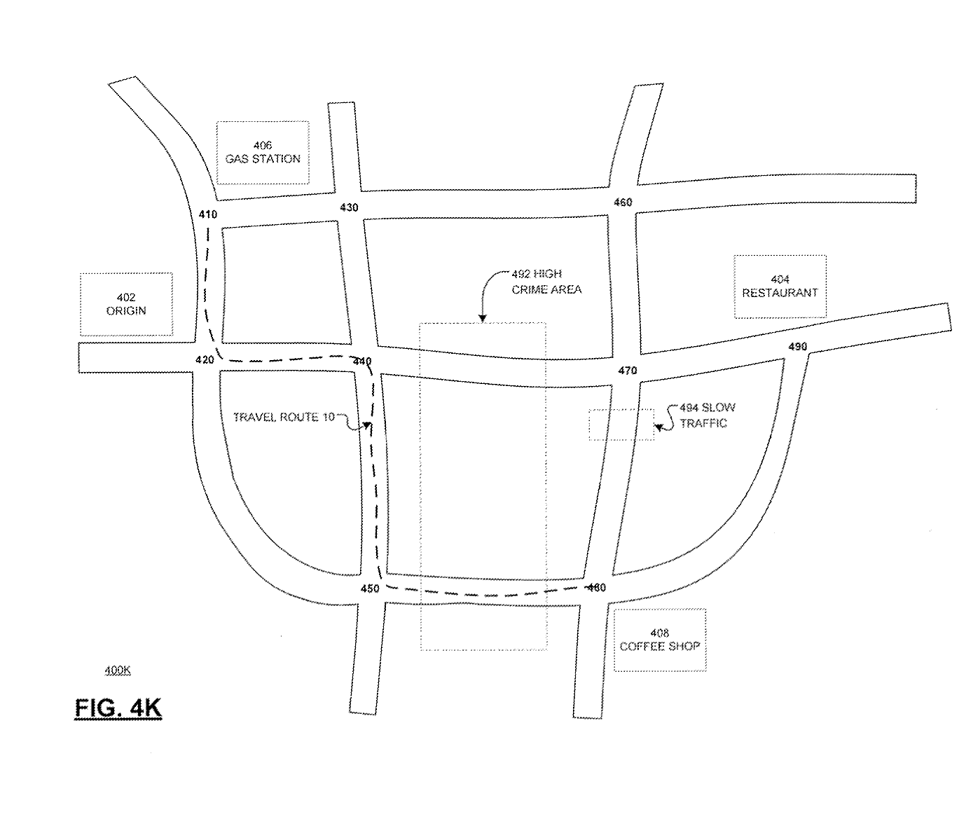

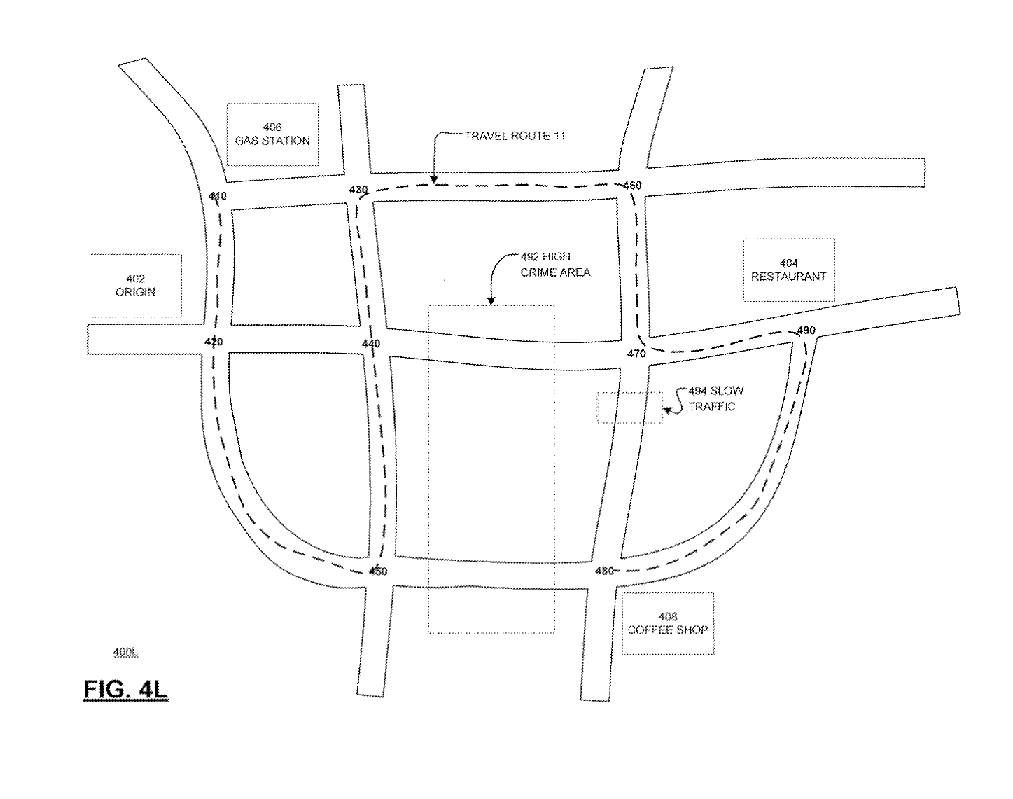

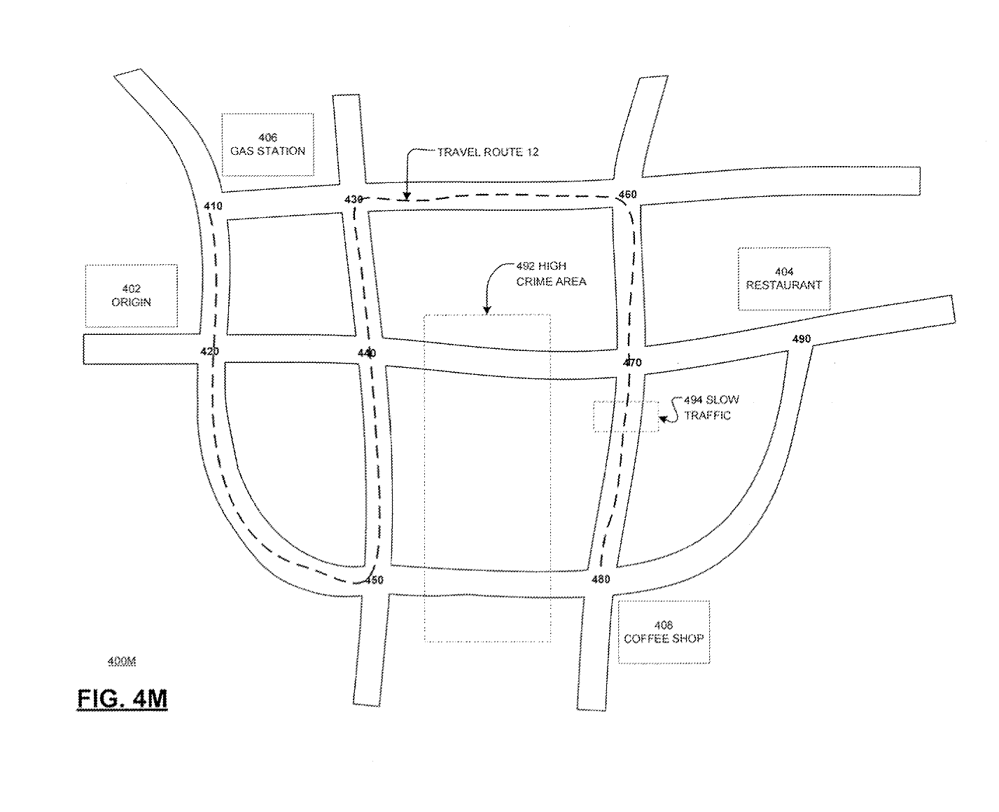

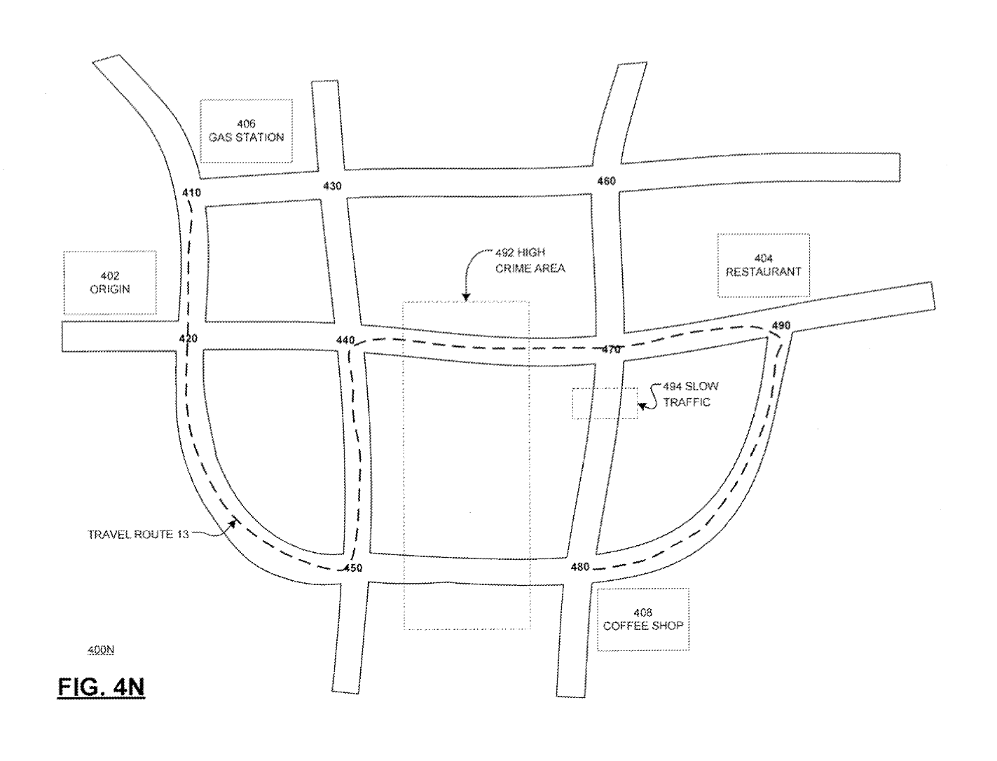

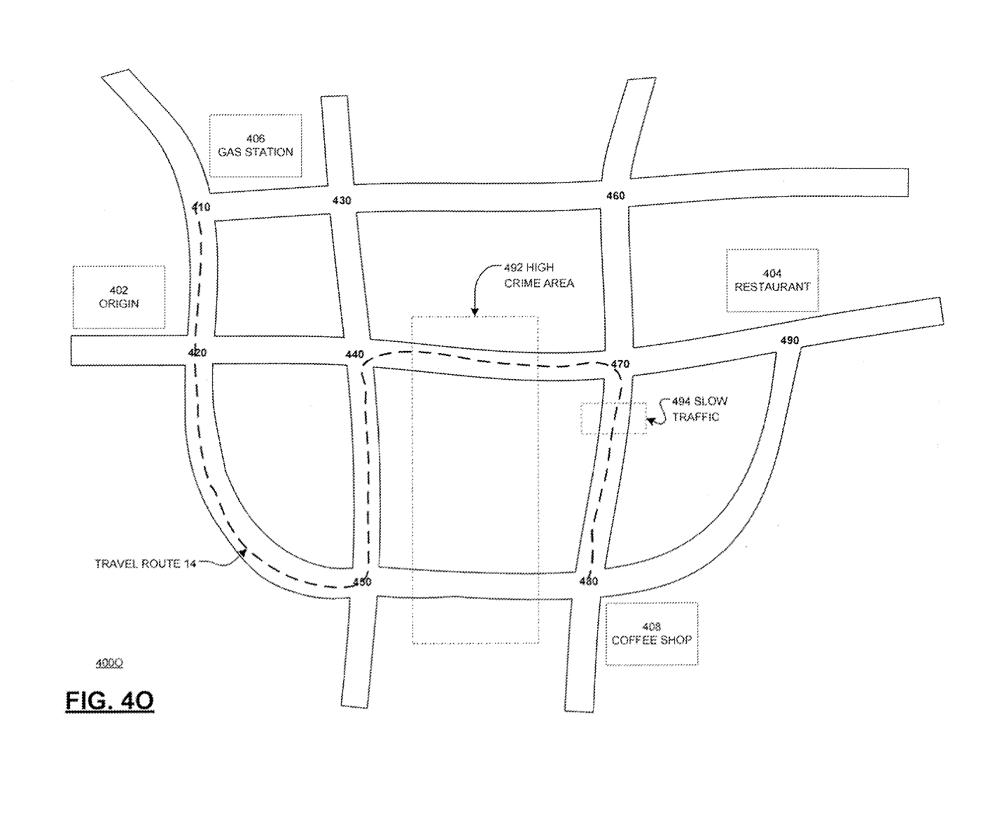

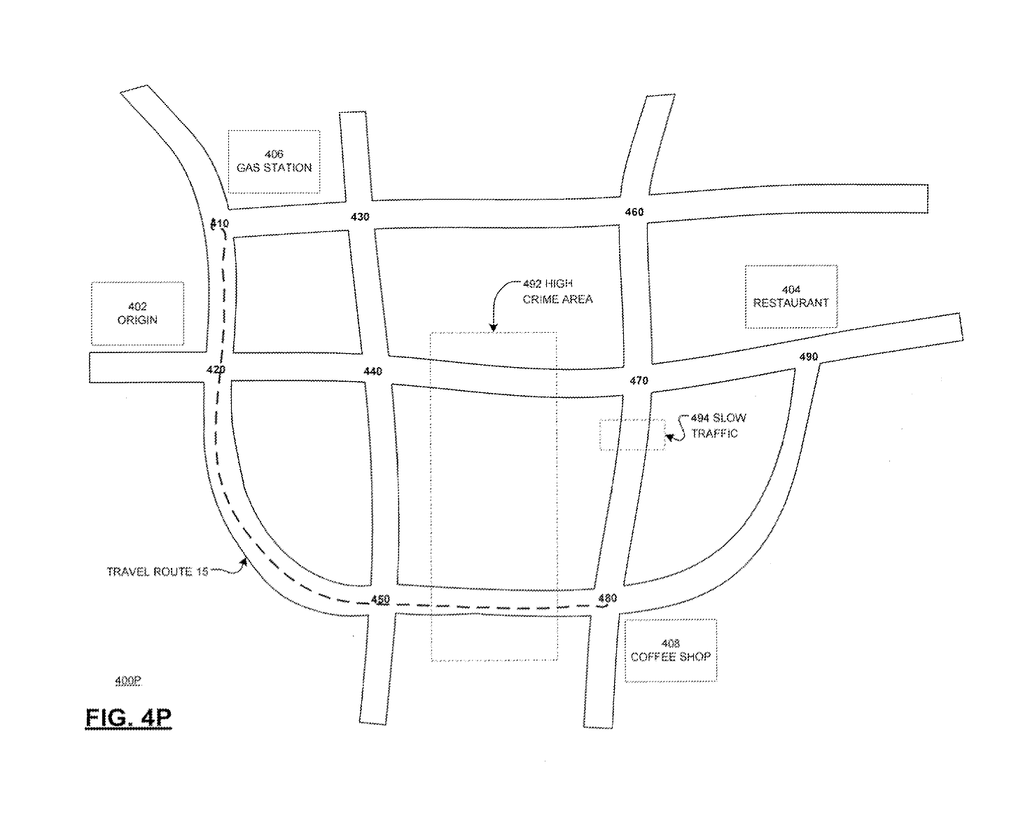

FIG. 4A is an illustration of an example associated with the example of the process 300 of FIG. 3. In this example, the user is using a smartphone which is a location-aware client device 110. The user has granted permissions on the smartphone 110 to allow the location-aware module 224 of the smartphone 110 to automatically provide location data 246 to the server 170.

In this example, the user drives (i.e., travels in an automobile) from an origin location 402 to a restaurant 404. Because the user is driving a car in an urban setting, the shortest navigable route between two points would be a paved road connecting the two points. That is, a route segment for the purposes of this example will be a paved road connecting the two points. In this example, the user drives along route segments 420-440, 440-430, 430-460, 460-470, and 470-490. As the user drives to the restaurant 404, the user's smartphone 110 automatically provides the user's location 246 and a corresponding date and time from the various locations along the user's travel route. Upon reaching the restaurant 404, the user performs a check-in by pressing a button on his smartphone 110.

In step 310, the navigational preferences and the travel history of the user are received, and stored as data 284 in the memory 280 of the server 170. In this example, the location data 246 and the respective dates and times, received from the user's smartphone 110 from various points along the travel route are stored in the memory 284 of the server 170 as the user's travel history.

Furthermore, the affinity values associated with the various locations and corresponding route segments on the travel route are increased due to the user's presence at these locations. These affinity values and the corresponding locations are stored in the user's navigational preferences. The restaurant 404 is stored as a point of interest in the user's navigational preferences, based on the check-in performed by the user.

The server 170 compares the user's travel route along route segments 420-440, 440-430, 430-460, 460-470, and 470-490 to other possible routes that the user could have taken. In this example, the user had not requested a travel route from the origin location 402 to the restaurant 404. Therefore, the server 170 is unable to compare the user's actual travel route to a calculated travel route provided to the user.

The server 170 compares the user's actual travel route to the shortest possible route, and the fastest possible route from the origin location 402 to the restaurant 404. The server 170 determines that the shortest route between the origin location 402 and the restaurant 404 is a travel route along route segments 420-440, 440-470, and 470-490. Similarly, the server 170 determines that the fastest route between the origin location 402 and restaurant 404 is along route segments 420-450, 450-480, and 480-490.

Based on the comparison, the server 170 determines that the user started out traveling along the shortest route but then deviated and consequently traveled along a relatively longer travel route. Specifically, the server 170 determines that the user deviated from the shortest travel path to seemingly avoid traveling along the route segment 440-470.

The server compares the avoided locations along the avoided route segment 440-470 to locations along the user's actual travel path. Based on publicly available information, the server 170 determines that the key difference between route segments (e.g., 420-440, 440-430, 430-460, 460-470, and 470-490) that were seemingly acceptable to the user, and route segment 440-470 avoided by the user, is that the route segment 440-470 falls within a high-crime area 492.

Based on the inferred cause, the server 170 adds a preference for avoiding high-crime areas to the user's stored navigational preferences. Furthermore, based on this avoidance, the server 170 associates negative affinity values with locations along route segment 440-470. These negative affinity values are also stored in the user's navigational preferences. Because of the negative affinity values, route segment 440-470 would be deemed less desirable in subsequent calculations for navigational instructions by the user.

Subsequently, the user stops at a gas station 406 to fill up his car's gas tank. While at the gas station 404, the user receives a call from a friend inviting him to a coffee shop 408. The user requests navigational instructions from the gas station 406 to the coffee shop 408. In step 320, the user's request for a travel route from the gas station 406 (i.e., the origin location) to the coffee shop 408 (i.e., the destination location), is received by the server 170.

In step 330, the server 170 calculates, in response to the received request, a travel route from the gas station 406 to the coffee shop 408, based on the stored navigational preferences and stored travel history of the user.

The server 170 begins by performing a heuristic search to explore the various possible routes from the gas station 406 to the coffee shop 408. The algorithm used to calculate the navigational instructions is implemented in software instructions 282.

In this example, the possible paths listed in no particular order, are illustrated in FIGS. 4B-4P. Some route segments in these possible paths are underlined for ease of reference.
Travel Route 1, illustrated in FIG. 4B involves traveling along route segments 410-430, 430-460, 460-470, 470-490, and 490-480.
Travel Route 2, illustrated in FIG. 4C involves traveling along route segments 410-430, 430-460, 460-470, and 470-480.
Travel Route 3, illustrated in FIG. 4D involves traveling along route segments 410-430, 430-440, 440-470, 470-490, and 490-480.
Travel Route 4, illustrated in FIG. 4E involves traveling along route segments 410-430, 430-440, 440-470, and 470-480.
Travel Route 5, illustrated in FIG. 4F involves traveling along route segments 410-430, 430-440, 440-450, and 450-480.
Travel Route 6, illustrated in FIG. 4G involves traveling along route segments 410-420, 420-440, 440-430, 430-460, 460-470, 470-490, and 490-480.
Travel Route 7, illustrated in FIG. 4H involves traveling along route segments 410-420, 420-440, 440-430, 430-460, 460-470, and 470-480.
Travel Route 8, illustrated in FIG. 4I involves traveling along route segments 410-420, 420-440, 440-470, 470-490, and 490-480.
Travel Route 9, illustrated in FIG. 4J involves traveling along route segments 410-420, 420-440, 440-470, and 470-480.
Travel Route 10, illustrated in FIG. 4K involves traveling along route segments 410-420, 420-440, 440-450, and 450-480.
Travel Route 11, illustrated in FIG. 4L involves traveling along route segments 410-420, 420-450, 450-440, 440-430, 430-460, 460-470, 470-490, and 490-480.
Travel Route 12, illustrated in FIG. 4M involves traveling along route segments 410-420, 420-450, 450-440, 440-430, 430-460, 460-470, and 470-480.
Travel Route 13, illustrated in FIG. 4N involves traveling along route segments 410-420, 420-450, 450-440, 440-470, 470-490, and 490-480.
Travel Route 14, illustrated in FIG. 4O involves traveling along route segments 410-420, 420-450, 450-440, 440-470, and 470-480.
Travel Route 15, illustrated in FIG. 4P involves traveling along route segments 410-420, 420-450, and 450-480.

The possible travel routes 1 through 15 (listed above) are then analyzed and ranked in accordance with the user's stored navigational preferences and the user's stored travel history. For example, the server 170 determines that Travel Routes 3, 4, 8, 9, 13, and 14 contain the route segment 440-470 which was previously avoided by the user. Based on negative affinity values associated with this route segment, the server associates a ranking with these travel routes which is lower than the remaining possible travel routes. The remaining possible travel routes are Travel Routes 1, 2, 5, 6, 7, 10, 11, 12, and 15.

As described above, the server 170 had inferred that the user avoided route segment 440-470 because it fell within a high-crime area 492, and had added to the user's stored navigational preferences, the user's preference for avoiding high-crime areas. The server 170 further determines that route segment 450-480 also falls within a high-crime area, which is incidentally the same high-crime area 492. The server 170 determines that Travel Routes 5, 10, and 15 include route segment 450-480. Consequently, based on the user's preference for avoiding high-crime areas, the server 170 associates with Travel Routes 5, 10, and 15, a ranking that is lower than the remaining possible travel routes. The remaining possible travel routes are Travel Routes 1, 2, 6, 7, 11, and 12.

The server 170 further takes into consideration the various environmental factors (e.g., street conditions) that affect each possible travel route but may or may not be included in the user's stored navigational preferences and the user's stored travel history. For example, the number of route segments, length of each route segment, traffic speed of each route segment, and so on can be used to associate rankings with the travel routes including those route segments.

Based on information received from various sources, the server 170 determines that traffic along route segment 470-480 is moving particularly slowly. Thus, the server 170 associates a ranking with travel routes containing route segment 470-480 which is lower than other remaining paths. Consequently, the server 170 associates with Travel Routes 2, 7, and 12, a ranking that is lower than the other remaining possible travel routes. The remaining possible travel routes are Travel Routes 1, 6, and 11.

The server 170 further considers the number of route segments included in each possible travel route. A route with fewer route segments may be less complex. For example, a travel route with fewer route segments may have fewer turns than a travel route with more route segments.

The server 170 determines that Travel Route 1 includes five segments, Travel Route 6 includes seven segments, and Travel Route 11 includes eight segments. Based on the number of route segments of each path, the server 170 arranges the travel routes as Travel Route 1 (five segments), Travel Route 6 (seven segments), and Travel Route 11 (eight segments).

The server 170 can provide for display the various remaining travel routes. The number of travel routes that may be provided by the server 170 is configurable. In this example, the user has specified that he wishes to receive the top three travel routes. Based on the user's preference, the server provides Travel Routes 1, 13, and 6 for display on the user's smartphone 110.

The user may then select a particular travel route and begin driving in accordance with the navigational instructions corresponding to that travel route. The travel route selected by the user may be used by the user's smartphone 110 for providing turn-by-turn driving directions.

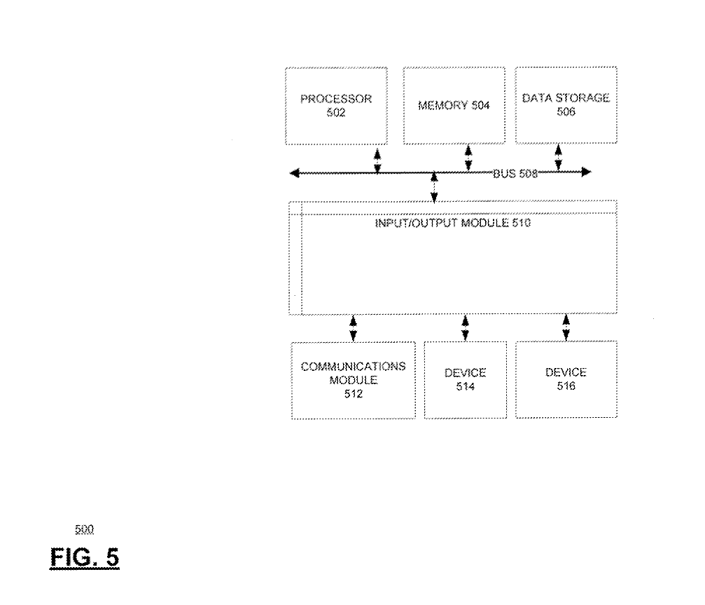

FIG. 5 conceptually illustrates an electronic system with which some aspects of the subject technology can be implemented. For example, FIG. 5 illustrates an example of a computer system 500 with which the client device 110 and/or the server 170 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client device 110, server 170) includes a bus 508 or other communication mechanism for communicating information, and a processor 502 (e.g., processor 220, processor 260) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 240, memory 280), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Examples of input/output modules 510 include data ports such as USB ports. The input/output module 510 is configured to connect to a communications module 512. Examples of communications modules 512 (e.g., communications module 222, communications module 262) include networking interface cards, such as Ethernet cards and modems. In certain aspects, the input/output module 510 is configured to connect to a plurality of devices, such as an input device 514 (e.g., input device 202) and/or an output device 516 (e.g., output device 204). Examples of input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Examples of output devices 516 include display devices, such as a CRT (cathode ray tube) or LCD (liquid crystal display) monitor, for displaying information to the user.

According to one aspect of the present disclosure, the client device 110 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 140) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that include bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations of the subject technology can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A computer-implemented method for calculating a travel route based on navigational preferences and travel history of a user, the method comprising:
storing navigational preferences and travel history of a user, wherein the stored navigational preferences comprise routing preferences and points of interest of the user, and wherein the stored travel history is comprised of location data from a respective date and time, received from a location-aware device associated with the user;
receiving a request from the user for a travel route from an origin location to a destination location; and
calculating, in response to the received request, the travel route from the origin location to the destination location, based on the stored navigational preferences and the stored travel history of the user.

2. The computer-implemented method of claim 1, further comprising:
providing, for display, the travel route from the origin location to the destination location.

3. The computer-implemented method of claim 1, further comprising:
comparing, based on the travel history of the user, an actual travel route of the user to at least one of the calculated travel route, a shortest travel route, or a fastest travel route from the origin location to the destination location;
detecting, based on the comparing, an avoided route;
comparing the avoided route to at least one location on the actual travel route;
inferring, based on the comparing, a cause of an avoidance of the avoided route; and
adding to the stored navigational preferences of the user, at least one of the avoided route or the inferred cause for the avoidance of the avoided route.

4. The computer-implemented method of claim 1, wherein at least one of the points of interest of the user is stored based on a check-in performed by the user.

5. The computer-implemented method of claim 1, wherein at least one of the points of interest of the user is stored based on an Internet search performed by the user.

6. The computer-implemented method of claim 1, wherein the calculating further comprises:
determining the travel route based on at least one of the navigational preferences, the travel history, and one or more environmental factors, wherein the one or more environmental factors comprise at least one of a crime statistic, a street condition, a demographic information, or a weather condition.

7. The computer-implemented method of claim 6, wherein the street condition comprises traffic data.

8. A system for calculating a travel route based on navigational preferences and travel history of a user, the system comprising:
a memory comprising instructions for calculating a travel route based on navigational preferences and travel history of a user;
a processor configured to execute the instructions to:
store the navigational preferences and the travel history of the user, wherein the stored navigational preferences comprise routing preferences and points of interest of the user, and wherein the stored travel history is comprised of location data from a respective date and time, received from a location-aware device associated with the user;
receive a request for the travel route from an origin location to a destination location;
calculate, in response to the received request, the travel route from the origin location to the destination location based on the stored navigational preferences and the stored travel history of the user; and
provide, for display, the travel route from the origin location to the destination location.

9. The system of claim 8, wherein the processor is further configured to:
compare, based on the travel history of the user, an actual travel route of the user to at least one of the calculated travel route, a shortest travel route, or a fastest travel route from the origin location to the destination location;
detect, based on the comparison, an avoided route;
compare at least one environmental factor of the avoided route to a corresponding environmental factor of at least one location on the actual travel route;
infer, based on the comparison, a cause of an avoidance of the avoided route; and
add to the stored navigational preferences of the user, at least one of the avoided route or the inferred cause for the avoidance of the avoided route.

10. The system of claim 8, wherein at least one of the points of interest of the user is stored based on a check-in performed by the user.

11. The system of claim 8, wherein at least one of the points of interest of the user is stored based on an Internet search performed by the user.

12. The system of claim 8, wherein the calculation further comprises:
determining the travel route based on the navigational preferences, the travel history, and one or more environmental factors, wherein the one or more environmental factors comprise at least one of a crime statistic, a street condition, a demographic information, or a weather condition.

13. The system of claim 12, wherein the street condition comprises traffic data.

14. A machine-readable storage medium comprising machine-readable instructions for causing a processor to execute a method for calculating a travel route based on navigational preferences and travel history of a user, the method comprising:
storing navigational preferences and travel history of a user, wherein the stored navigational preferences comprise routing preferences and points of interest of the user, and wherein the stored travel history is comprised of location data from a respective date and time, received from a location-aware device associated with the user;
receiving a request from the user for a travel route from an origin location to a destination location;
calculating, in response to the received request, the travel route from the origin location to the destination location, based on the stored navigational preferences and the stored travel history of the user; and
providing for display, the travel route from the origin location to the destination location.

15. The machine-readable storage medium of claim 14, wherein the method further comprises:
comparing, based on the travel history of the user, an actual travel route of the user to at least one of the calculated travel route, a shortest travel route, or a fastest travel route from the origin location to the destination location;
detecting, based on the comparing, an avoided route;
comparing at least one environmental factor of the avoided route to a corresponding environmental factor of at least one location on the actual travel route;
inferring, based on the comparing, a cause of an avoidance of the avoided route; and
adding to the stored navigational preferences of the user, at least one of the avoided route or the inferred cause for the avoidance of the avoided route.

16. The machine-readable storage medium of claim 14, wherein at least one of the points of interest of the user is stored based on a check-in performed by the user.

17. The machine-readable storage medium of claim 14, wherein at least one of the points of interest of the user is stored based on an Internet search performed by the user.

18. The machine-readable storage medium of claim 14, wherein the method further comprises:
determining the travel route based on the navigational preferences, the travel history, and one or more environmental factors, wherein the one or more environmental factors comprise at least one of a crime statistic, a street condition, a demographic information, or a weather condition.

19. The machine-readable storage medium of claim 18, wherein the street condition comprises traffic data.

20. The machine-readable storage medium of claim 18, wherein the street condition comprises a street closure.
